(19) United States
(12) Patent Application Publication
(10) Pub. No.: US 2023/0142096 A1
(43) Pub. Date: May 11, 2023

(54) METHOD AND STIRRING ELEMENT DEVICE FOR MIXING MEDIUM VISCOUS TO HIGH VISCOUS FLUIDS AND/OR PASTES

(71) Applicant: EKATO Rühr- und Mischtechnik GmbH, Schopfheim (DE)

(72) Inventors: Tobias KNOBLOCH, Murg-Hänner (DE); Marco KÖNIG, Schopfheim (DE); Wolfgang LAST, Lörrach (DE); Benjamin MULTNER, Wehr (DE); Benedict KOHM, Maulburg (DE); Klaus GEZORK, Schopfheim (DE)

(21) Appl. No.: 17/917,548

(22) PCT Filed: Apr. 7, 2021
(86) PCT No.: PCT/EP2021/059050

§ 371 Date: Oct. 6, 2022

(30) Foreign Application Priority Data
Apr. 8, 2020 (DE) 10 2020 109 865.0

(51) Int. Cl. B01F 27/1125; B01F 23/47; B01F 23/43; B01F 27/072; B01F 27/90; B01F 27/1122; B01F 27/191

(52) U.S. Cl. CPC B01F 27/11253; B01F 23/47; B01F 23/43; B01F 27/07261; B01F 27/90; B01F 27/1122; B01F 27/191

(57) ABSTRACT

A method in which a medium viscous to highly viscous fluid and/or a medium viscous to highly viscous suspension are/is mixed by means of an agitator device that is driven by a drive shaft, wherein

the fluid and/or the suspension are/is brought into a multi-dimensional flow by means of a close-clearance stirring blade (14) of the agitator device, and a flow resistance is minimized along a shaft direction in a shaft proximity.

This application is based on and incorporates herein by reference the German patent application DE 10 2020 109 865.0 filed on Apr. 8, 2020 and the PCT application PCT/EP2021/059050 filed on Apr. 7, 2021.

### STATE OF THE ART

The invention concerns a method in which a medium viscous to highly viscous fluid and/or a medium viscous to highly viscous suspension are/is mixed by means of an agitator device that is driven by a drive shaft, and an agitator device.

A plurality of methods, respectively agitator devices, for a mixing of fluids and/or suspensions of medium viscosity to high viscosity are already known from the state of the art. For example, in DE 25 57 979 C2 a stirring device is used with two outer stirring elements which are connected to a drive shaft, wherein respectively one inner stirring element is arranged between the outer stirring elements and the drive shaft, said inner stirring element being configured to create an upwards-directed or downwards-directed flow in an axial direction of the drive shaft. The inner stirring elements are herein arranged at a pitch angle with an inclination relative to a rotation plane. Similar arrangements of stirring elements are further known, for example, from documents CH 593 711 A4, CN 204 768 523 U, DE 603 17 772 T2, DE 10 2007 054 428 Al, EP 0 063 171 A2 or JP 44 32 438 B2, wherein a geometry and/or a pitch angle of the inner stirring elements has been modified and further developed in a variety of manners. However, all the publications mentioned above have in common that a flow in an axial direction is to be created or augmented by means of inner stirring elements, which necessarily involves increased flow resistance in a proximity of the drive shaft, and thus an increased power demand for generating a torque.

The objective of the invention is in particular to provide a generic method as well as a generic agitator device with improved characteristics regarding efficiency. The objective is achieved according to the invention while advantageous implementations and further developments of the invention may be gathered from the subclaims.

### ADVANTAGES OF THE INVENTION

The invention is based on a method in which a medium viscous to highly viscous fluid and/or a medium viscous to highly viscous suspension, in particular a medium viscous to highly viscous paste, are/is mixed by means of an agitator device that is driven by a drive shaft.

It is proposed that the fluid and/or the suspension are/is brought into a multi-dimensional flow by means of a close-clearance stirring blade of the agitator device, and a flow resistance is minimized along a shaft direction in a shaft proximity.

Such an implementation advantageously allows providing an especially efficient method for a mixing of medium viscous to highly viscous fluids and/or suspensions. It is in particular advantageously possible to provide an especially energy-efficient method as, due to the minimization of the flow resistance along the shaft direction in the shaft proximity, an electric power required for driving the agitator device can be reduced while maintaining an at least constant, in particular improved, mixing rate. Especially advantageously, the increased energetic efficiency, in particular in a mixing of highly viscous fluids and/or suspensions occurring, for example, in the production of synthetic materials, enables achieving considerable saving of costs. In addition, experimental studies carried out by the applicant have produced results which may be considered as completely surprising in view of the state of the art. Contrarily to previous assumptions, it could be shown that when inner stirring blades are dispensed with, besides the energetic advantages mentioned above, it is especially advantageously also possible to significantly improve a mixing rate of the fluid and/or the suspension in an axial direction. This means that the present invention constitutes a complete abandonment of the approach of previous methods, respectively of the implementations of previous agitator devices, for a mixing of medium viscous to highly viscous fluids and/or suspensions.

The method and/or the agitator device are/is configured for a mixing of medium viscous to highly viscous fluids and/or suspensions having a dynamic viscosity of preferentially at least 500 mPa s, in particular at least 1,000 mPa s, advantageously at least 10,000 mPa s, especially advantageously at least 20,000 mPa s, preferably at least 40,000 mPa s and particularly preferably at least 50,000 mPa s.

The drive shaft of the agitator device is connectable to a drive unit which may, for example, comprise an electromotor for a generation of a drive momentum, a coupling and/or transmission element for a transfer of the drive momentum, and further elements. The drive unit may be part of the agitator device. Preferentially the drive shaft of the agitator device is connectable to a plurality of different external drive units.

The close-clearance stirring blade comprises at least one outer portion which is in an operative state of the agitator device movable, by means of a drive momentum provided via the drive shaft, on a movement path in a proximity of an inner wall, in particular a side wall, of a stirring container which the fluid that is to be mixed and/or the suspension that is to be mixed are/is arranged in. Herein a maximum distance from the portion of the close-clearance stirring blade to the inner wall, in particular the side wall, of the stirring container preferably corresponds to maximally 10%, preferentially to maximally 8% and especially preferentially to no more than 5% of a diameter of the stirring container. The movement path of the portion of the close-clearance stirring blade is in particular oriented at least substantially parallel to the wall, in particular the side wall, of the stirring container, and in particular extends in a proximity of the wall, in particular the side wall, of the stirring container.

The multi-dimensional flow herein comprises at least two flow components, which are oriented in different spatial directions. The multi-dimensional flow comprises at least an axial flow component, which is oriented at least substantially parallel to a main extension of the drive shaft. In addition to the axial flow component, the multi-dimensional flow may comprise at least one radial flow component, which is oriented at least substantially perpendicularly to the axial flow component, and/or at least one tangential flow component, which is oriented at least substantially perpendicularly both to the axial flow component and to the radial flow component. Preferably the flow components are oriented at an at least substantially right angle to one another, which differs from a 90° angle preferentially by less than 8°, preferably by less than 5° and particularly preferably by less than 2°. The shaft direction is preferably oriented at least substantially parallel to a main extension of the drive shaft and differs from a direction of the main extension by an angle of preferentially maximally 8°, preferably maximally 5° and particularly preferably no more than 2°. A “main extension” of an object is here to mean a longest edge of a smallest geometrical rectangular cuboid which just still completely encloses the object. The shaft proximity extends preferably over a region of an imaginary cylinder whose main extension runs substantially parallel to the main extension of the drive shaft and whose radius corresponds to at least 10%, advantageously at least 20%, preferably at least 30% and particularly preferably at least 40% of a radius of the stirring container.

Furthermore, it is proposed that the multi-dimensional flow of the fluid and/or the suspension is created at least partly by means of at least one further close-clearance stirring blade of the agitator device, which is arranged offset along the drive shaft. In this way advantageously an especially even mixing of the medium viscous to highly viscous fluid and/or the medium viscous to highly viscous suspension is achievable. For applications involving large volumes of medium viscous to highly viscous fluids and/or medium viscous to highly viscous suspensions that are to be mixed, it is conceivable that a multi-dimensional flow is created by means of a plurality of close-clearance stirring blades of the agitator device, which are arranged respectively offset from each other along the drive shaft.

It is moreover proposed that with respect to a circumferential direction of the drive shaft, the further close-clearance stirring blade is driven at an angular offset to the close-clearance stirring blade. In this way advantageously an especially even mixing of the medium viscous to highly viscous fluid and/or the medium viscous to highly viscous suspension is achievable. It is furthermore possible to increase a stability of the drive shaft.

It is also proposed that in a view direction along the drive shaft, a plurality of at least four close-clearance stirring blades are driven simultaneously, the stirring blades being driven, in a circumferential direction of the drive shaft, respectively offset from one another by an angle that corresponds to a quotient of 360° and a number of stirring blades. In the case of precisely four close-clearance stirring blades which are driven simultaneously, these are therefore arranged respectively offset from each other in the circumferential direction of the drive shaft. In this way advantageously an especially even mixing of the medium viscous to highly viscous fluid and/or the medium viscous to highly viscous suspension in the circumferential direction of the drive shaft is advantageously achievable.

Beyond this it is proposed that the stirring blade is driven at an acute pitch angle relative to a plane that is perpendicular to the drive shaft. Such an implementation advantageously allows further improving a mixing of the medium viscous to highly viscous fluid and/or the medium viscous to highly viscous suspension in the circumferential direction of the drive shaft. The acute pitch angle may herein be an angle of maximally 80°, in particular maximally 70°, especially advantageously no more than 60° and particularly preferably between 40° and 50°. Preferentially the stirring blade is moved at an acute pitch angle of at least substantially 45° with respect to the plane that is perpendicular to the drive shaft.

It is further proposed that the multi-dimensional flow of the fluid and/or the suspension is created at least partly by means of at least one close-clearance counter-stirring blade which, viewed along the drive shaft, is situated opposite the close-clearance stirring blade and is arranged at a same level. In this way it is advantageously possible to improve a mixing of the fluid and/or the suspension in a radial and/or tangential flow direction and to achieve an especially even and stable drive by the drive shaft. In an advantageous implementation, the close-clearance counter-stirring blade is driven at a further acute pitch angle with respect to the plane that is perpendicular to the drive shaft. An absolute value of the further acute pitch angle is preferably essentially equivalent to the absolute value of the acute pitch angle of the close-clearance stirring blade with respect to the plane that is perpendicular to the drive shaft. Preferentially the close-clearance stirring blade and the close-clearance counter-stirring blade have geometries that are substantially identical to each other and have dimensions that are substantially identical to each other. The close-clearance stirring blade and the close-clearance counter-stirring blade are preferably convertible into one another by a rotation of 180° in the circumferential direction of the drive shaft.

It is also proposed that a drive momentum is transferred from the drive shaft to the stirring blade by means of a connection element of the agitator device, whose, in particular essentially oval, preferably circle-shaped cross section minimizes the flow resistance along the shaft direction in the shaft proximity. By using a connection element whose outer contour minimizes, due to its oval, in particular circle-shaped cross section, the flow resistance along the shaft direction in the shaft proximity, it is advantageously possible to provide an especially energetically efficient method for a mixing of medium viscous to highly viscous fluids and/or suspensions. At the same time a reliable transfer of the drive momentum from the drive shaft to the at least one close-clearance stirring blade is achievable.

Furthermore, it is proposed that, due to the minimized flow resistance, the connection element is moved with a percentage of the drive momentum transferred from the drive shaft to the close-clearance stirring blade that is smaller than 10%, preferably smaller than 5%. This advantageously enables providing an especially efficient method for a mixing of medium viscous to highly viscous fluids and/or suspensions. In particular for the purpose of mixing highly viscous fluids and/or suspensions having a dynamic viscosity of 50,000 mPa s or more, an energy input for generating a drive momentum necessary for the mixing is especially advantageously reducible and thus significant saving of costs is achievable.

It is also proposed that a layer of the fluid and/or the suspension that is close to the bottom is brought into a flow by means of a bottom stirring blade of the agitator device. In this way an especially even mixing of the fluid and/or the suspension is advantageously also achievable in the layer of the fluid and/or the suspension that is close to the bottom. It is moreover advantageously possible to counteract a sedimentation of particles which are to be suspended in the fluid and/or are suspended in the suspension, such sedimentation being undesirable in many application cases. Preferentially the layer of the fluid and/or the suspension that is close to the bottom comprises a sub-quantity of the fluid and/or the suspension that takes up, from the bottom of a stirring container, at least 15% of a total holding capacity of the stirring container.

The invention is further based on an agitator device which is configured for a mixing of a medium viscous to highly viscous fluid and/or a medium viscous to highly viscous suspension, comprising at least one close-clearance stirring blade, a drive shaft and a connection element which connects the stirring blade to the drive shaft.

It is proposed that the connection element has an outer contour that is configured to minimize a flow resistance of a multi-dimensional flow of the fluid and/or the suspension, which is generated by the stirring blade in an operative state, along a shaft direction and in a shaft proximity. This advantageously allows providing an agitator device with an especially high level of energy efficiency. The connection element may be connected to the drive shaft by substance-to-substance bond, for example by a welding and/or soldering and/or gluing connection. Preferably the connection element is connected to the drive shaft by a form-fit and/or force-fit connection, in particular by a shaft-hub connection. The close-clearance stirring blade may be implemented integrally with the connection element. “Implemented integrally” is to mean at least connected by substance-to-substance bond, for example by a welding process and/or a gluing process, etc., and is especially advantageously to mean molded-on, like by production from a cast and/or by production in a one-component and/or multi-component injection-molding process. Preferably the close-clearance stirring blade is connected to the connection element by form-fit and/or force-fit connection, for example via a plug connection, a screw connection or something like that.

“Configured” is in particular to mean specifically designed and/or equipped. By an object being configured for a certain function is to be understood that the object fulfills and/or carries out said certain function in at least one application state and/or operation state.

It is further proposed that the connection element has an essentially oval, preferably circle-shaped, cross section. This advantageously enables a minimization of the flow resistance along the shaft direction in the shaft proximity by particularly simple technical means. At the same time a reliable transfer of a drive momentum from the drive shaft to the at least one close-clearance stirring blade is advantageously achievable. The connection element may have along its main extension at least one cross-section modification, like a cross-section tapering and/or a modification of a shape of the cross section, for example a transition from an oval cross section to a circle-shaped cross section, or something like that. Preferably a shape and a surface area of the cross section of the connection element are at least substantially constant along the main extension of the connection element. This advantageously allows simplifying a manufacturing process and thus achieving a saving of costs.

Beyond this a stirring system is proposed with a stirring container and with an agitator device, wherein the close-clearance stirring blade is arranged within the stirring container at least partly such that it is movable in a proximity of an inner wall of the stirring container. This advantageously allows providing an especially efficient and reliable stirring system with advantageous flow characteristics.

The method according to the invention and the agitator device according to the invention are herein not to be limited to the application and implementation mentioned above. In particular, to fulfill a functionality that is described here, the method according to the invention and the agitator device according to the invention may comprise a number of individual elements, components and units, as well as method steps, that differs from a number given here.

### DRAWINGS

Further advantages will become apparent from the following description of the drawings. In the drawings an exemplary embodiment of the invention is illustrated. The drawings, the description and the claims contain a plurality of features in combination. Someone skilled in the art will purposefully consider the features separately and will find further expedient combinations.

It is shown in:

FIG. 1 a stirring system with a stirring container and with an agitator device arranged in the stirring container,

FIG. 2 the agitator device in a view direction along a drive shaft of the agitator device,

FIG. 3 a close-clearance stirring blade of the agitator device, and

FIG. 4 a schematic flow chart concerning a method in which a medium viscous to highly viscous fluid and/or a medium viscous to highly viscous fluid are/is mixed by means of an agitator device.

### DESCRIPTION OF THE EXEMPLARY EMBODIMENT

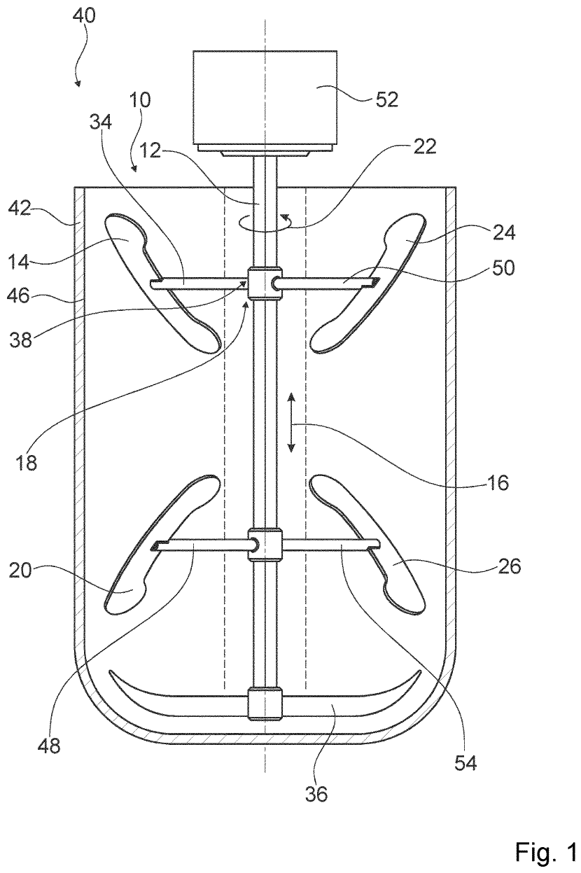

FIG. 1 shows a stirring system 40. The stirring system 40 comprises a stirring container 42 and an agitator device 10. The stirring system 40 comprises a drive unit 52. The drive unit 52 is configured to provide a drive momentum and to transfer said drive momentum to a drive shaft 12 of the agitator device 10.

The agitator device 10 is configured for mixing a medium viscous to highly viscous fluid and/or a medium viscous to highly viscous suspension. The agitator device 10 comprises the drive shaft 12 and a close-clearance stirring blade 14. The agitator device 40 comprises a connection element 34, which connects the close-clearance stirring blade 14 to the drive shaft 12. The close-clearance stirring blade 14 is arranged in the stirring container 42 at least partly in such a way that it is movable in a proximity 44 of an inner wall 46 of the stirring container 42. In an operative state of the agitator device 10 the close-clearance stirring blade 14 is movable around the drive shaft 12 in a circumferential direction 22.

The connection element 34 has an outer contour 38. The outer contour 38 is configured to minimize a flow resistance of a multi-dimensional flow (not shown), generated by the stirring blade 14 in an operative state, of the fluid and/or the suspension along a shaft direction 16 in a shaft proximity 18. The connection element 34 has an at least essentially oval cross section 56. In the present case the cross section of the connection element 34 is essentially circle-shaped.

The agitator device 10 comprises a further close-clearance stirring blade 20. The further close-clearance stirring blade 20 is arranged along the drive shaft 12 offset to the close-clearance stirring blade 14. The agitator device 10 comprises a further connection element 48 connecting the further close-clearance stirring blade 20 to the drive shaft 12. In the operative state of the agitator device 10, the further close-clearance stirring blade 20 is drivable at an angular offset to the close-clearance stirring blade 13 with respect to a circumferential direction 22 of the drive shaft 12.

The agitator device 10 comprises a close-clearance counter-stirring blade 24. Viewed along the drive shaft 12, the close-clearance counter-stirring blade 24 is arranged at the same level as and opposite to the close-clearance stirring blade 14. The close-clearance counter-stirring blade 24 is connected to the drive shaft 12 via a further connection element 50 of the agitator device 10.

The agitator device 10 comprises a further close-clearance counter-stirring blade 26. Viewed along the drive shaft 12, the further close-clearance counter-stirring blade 26 is arranged at the same level as and opposite to the further close-clearance stirring blade 20. The further close-clearance counter-stirring blade 26 is connected to the drive shaft 12 via a further connection element 54 of the agitator device 10.

The close-clearance stirring blade 14, the further close-clearance stirring blade 20, the close-clearance counter-stirring blade 24 and the further close-clearance counter-stirring blade 26 have geometries that are substantially identical to one another and dimensions that are substantially identical.

The further connection elements 48, 50, 54 each have a geometry and a dimension that is substantially identical to the connection element 34, and they are also configured to minimize a flow resistance of the fluid and/or the suspension along the shaft direction 16 in a shaft proximity 18.

The agitator device 10 comprises a bottom stirring blade 36. The bottom stirring blade 36 is connected to the drive shaft 12 and is configured to bring a layer of the fluid and/or the suspension that is close to the bottom into a flow.

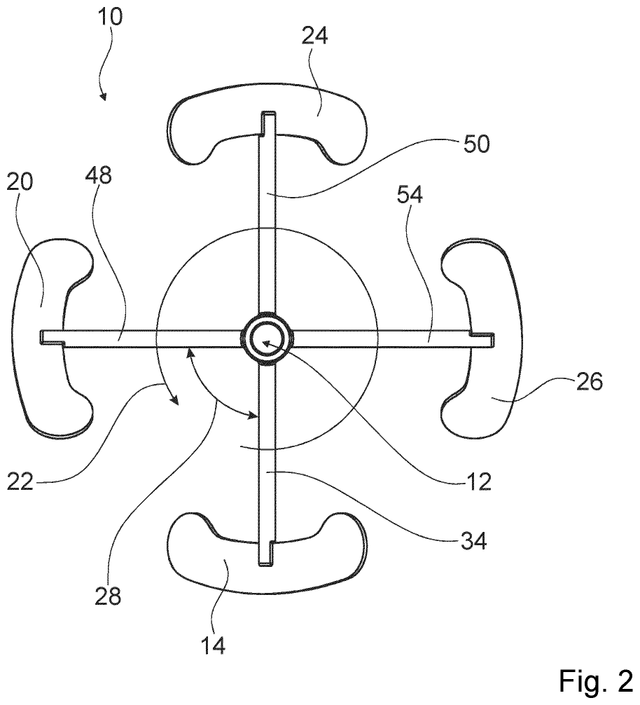

FIG. 2 shows a schematic view of the agitator device 10 in a view direction along the drive shaft 12. The agitator device 10 comprises a plurality of close-clearance stirring blades 14, 20, 24, 26 which are arranged, in a circumferential direction 22 of the drive shaft 12, respectively offset to one another by an angle 28. The angle 28 is equivalent to a quotient of 360° and a number of stirring blades. In the present exemplary embodiment the agitator device 10 comprises a number of precisely four close-clearance stirring blades, namely the close-clearance stirring blade 14, the further close-clearance stirring blade 20, the close-clearance counter-stirring blade 24 and the further close-clearance counter-stirring blade 26, such that the angle 28 is here equivalent to an angle of 90°.

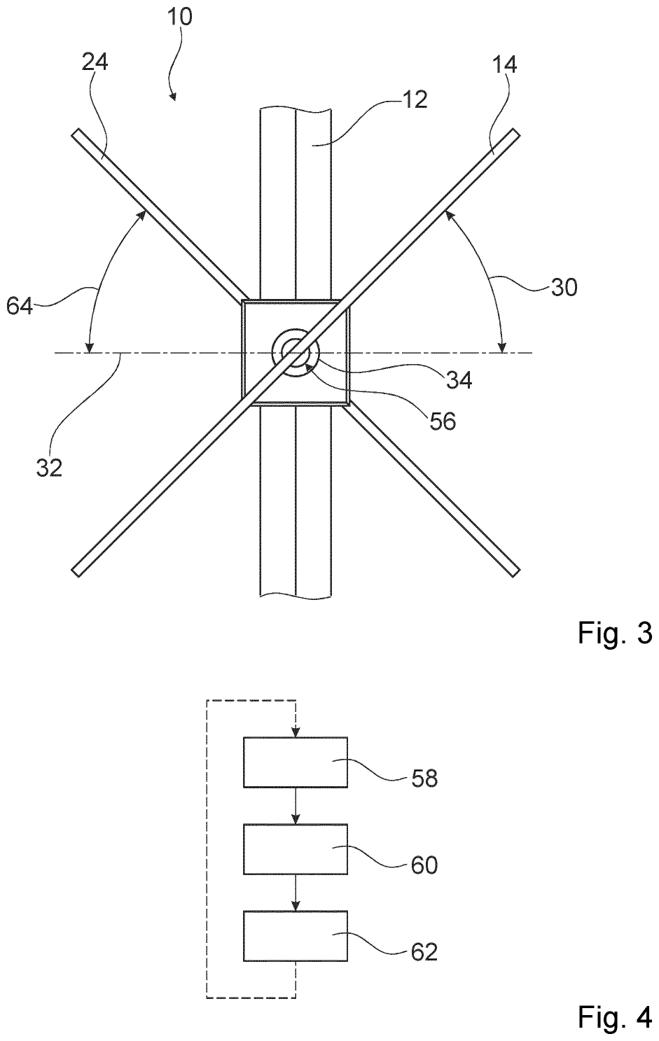

FIG. 3 shows a schematic partial view of the agitator device 10 with a view direction onto the close-clearance stirring blade 14 along a plane 32 that is perpendicular to the drive shaft 12. The stirring blade 14 is arranged at an acute pitch angle 30 relative to the plane 32 that is perpendicular to the drive shaft 12. In the present exemplary embodiment the acute pitch angle 30 is equivalent to an angle of 45°. The close-clearance counter-stirring blade 24 is arranged at a further acute pitch angle 64 relative to the plane 32 that is perpendicular to the drive shaft 12. The further acute pitch angle 64 is identical to the acute pitch angle 30 and in the present case also has an absolute value of 45°.

FIG. 4 shows a schematic flow chart of a method in which a medium viscous to highly viscous fluid and/or a medium viscous to highly viscous suspension are/is mixed by means of the agitator device 10 that is driven by the drive shaft 12. In a first method step 58 the stirring container 42 is filled with the medium viscous to highly viscous fluid and/or the medium viscous to highly viscous suspension. In a further method step 60 the agitator device 10 is arranged in the stirring container 42. In a further method step 62 the agitator device 10 is set into operation. A drive momentum provided by the drive unit 52 is transferred to the drive shaft 12 and, for the purpose of driving the agitator device 10, brings the drive shaft 12 into a rotary movement in the circumferential direction 22. The drive momentum is transferred from the drive shaft 12 to the close-clearance stirring blade 14 by means of the connection element 34 of the agitator device 10, bringing the stirring blade 14 into a rotary movement in the circumferential direction 22. The stirring blade 14 is driven at the acute pitch angle 30 relative to the plane 32 that is perpendicular to the drive shaft 12. The fluid and/or the suspension is herewith brought into a multi-dimensional flow. A flow resistance of the multi-dimensional flow is herein minimized along the shaft direction 16 in the shaft proximity 18. The flow resistance along the shaft direction 16 in the shaft proximity 18 is herein minimized due to the circle-shaped cross section 56 of the connection element 34. As a result of the minimized flow resistance, the connection element 34 is driven with a percentage of the drive momentum transferred from the drive shaft to the close-clearance stirring blade 14 that is smaller than 5%. The multi-dimensional flow of the fluid and/or the suspension is created at least partly by the close-clearance counter-stirring blade 24 that is, viewed along the drive shaft, opposite the close-clearance stirring blade 14 and is arranged at a same level. The multi-dimensional flow of the fluid and/or the suspension is moreover created at least partly by means of the further close-clearance stirring blade 20 of the agitator device 10, which is arranged offset along the drive shaft 12. With respect to a circumferential direction 22 of the drive shaft 12, the further close-clearance stirring blade 20 is driven at an angular offset to the close-clearance stirring blade 14. In a view direction along the drive shaft 12, the four close-clearance stirring blades 14, 20, 24, 26 are driven simultaneously, wherein the close-clearance stirring blades 14, 20, 24, 26 are driven, in the circumferential direction 22 of the drive shaft 12, respectively offset from one another by the angle 28. The layer of the fluid and/or the suspension that is close to the bottom is brought into a flow by means of the bottom stirring blade 36 of the agitator device 10. In a further method step 62, following sufficient mixing of the medium viscous to highly viscous fluid and/or the medium viscous to highly viscous suspension, the agitator device 10 is switched off and is removed from the stirring container 42. The mixed medium viscous to highly viscous fluid and/or the mixed medium viscous to highly viscous suspension may then be taken from the stirring container 42 and, for example, may be fed to a further processing procedure or may be packaged as an end product. The method may be designed as a batch process, with discontinuous execution of the method steps 58, 60, 62. It is however also conceivable that the further method step 60 is carried out continuously, with a sub-quantity of a mixed fluid and/or mixed suspension being conveyed out of the stirring container 42 and a quantity of fluid and/or suspension that is to be mixed being continuously fed to the stirring container 42.

### REFERENCE NUMERALS

10 agitator device

12 drive shaft

14 close-clearance stirring blade

16 shaft direction

18 shaft proximity

20 further close-clearance stirring blade

22 circumferential direction

24 close-clearance counter-stirring blade

26 further close-clearance counter-stirring blade

28 angle

30 acute pitch angle

32 perpendicular plane

34 connection element

36 bottom stirring blade

38 outer contour

40 stirring system

42 stirring container

44 proximity

46 inner wall

48 further connection element

50 further connection element

52 drive unit

54 further connection element

56 cross section

58 first method step

60 further method step

62 further method step

64 further acute pitch angle

1. A method in which a medium viscous to highly viscous fluid and/or a medium viscous to highly viscous suspension are/is mixed by means of an agitator device (10) that is driven by a drive shaft, wherein the fluid and/or the suspension are/is brought into a multi-dimensional flow by means of a close-clearance stirring blade of the agitator device, and a flow resistance is minimized along a shaft direction in a shaft proximity that extends over a region of an imaginary cylinder, whose main extension runs substantially parallel to a main extension of the drive shaft and whose radius corresponds to at least 10% of a radius of a stirring container.

2. The method according to claim 1, wherein the multi-dimensional flow of the fluid and/or the suspension is created at least partly by means of at least one further close-clearance stirring blade of the agitator device, which is offset along the drive shaft.

3. The method according to claim 2, wherein with respect to a circumferential direction of the drive shaft, the further close-clearance stirring blade is driven at an angular offset to the close-clearance stirring blade.

4. The method according to claim 3, wherein in a view direction along the drive shaft, a plurality of at least four close-clearance stirring blades are driven simultaneously, the close-clearance stirring blades being driven, in a circumferential direction of the drive shaft, respectively offset from one another by an angle that corresponds to a quotient of 360° and a number of stirring blades.

5. The method according to claim 1, wherein the stirring blade is driven at an acute pitch angle relative to a plane that is perpendicular to the drive shaft.

6. The method according to claim 1, wherein the multi-dimensional flow of the fluid and/or the suspension is created at least partly by means of at least one close-clearance counter-stirring blade which, viewed along the drive shaft, is situated opposite the close-clearance stirring blade and is arranged at a same level.

7. The method according to claim 1, wherein a drive momentum is transferred from the drive shaft to the stirring blade by means of a connection element of the agitator device, whose, in particular essentially oval, preferably circle-shaped cross section minimizes the flow resistance along the shaft direction in the shaft proximity.

8. The method according to claim 7, wherein due to the minimized flow resistance, the connection element is driven with a percentage of the drive momentum transferred from the drive shaft to the close-clearance stirring blade that is smaller than 10%.

9. The method according to claim 1, wherein a layer of the fluid and/or the suspension that is close to a bottom is brought into a flow by means of a bottom stirring blade of the agitator device.

10. An agitator device which is configured for a mixing of a medium viscous to highly viscous fluid and/or a medium viscous to highly viscous suspension, in particular for an execution of the method according to claim 1, comprising at least one close-clearance stirring blade, a drive shaft, and a connection element which connects the stirring blade to the drive shaft, wherein the connection element has an outer contour that is configured to minimize a flow resistance of a multi-dimensional flow of the fluid and/or the suspension, which is generated by the stirring blade in an operative state, along a shaft direction in a shaft proximity that extends over a region of an imaginary cylinder, whose main extension runs substantially parallel to a main extension of the drive shaft and whose radius corresponds to at least 10% of a radius of a stirring container.

11. The agitator device according to claim 10, wherein the connection element has an at least essentially oval, preferably circle-shaped cross section.

12. A stirring system with a stirring container and with an agitator device according to claim 10, in particular for an execution of a method according to claim 1, wherein the close-clearance stirring blade is arranged within the stirring container at least partly such that it is movable in a proximity of an inner wall of the stirring container, wherein a maximum distance of the proximity to the inner wall corresponds to maximally 10% of a diameter of the stirring container.
